(19) United States
(12) Patent Application Publication
(10) Pub. No.: US 2007/0083022 A1
(43) Pub. Date: Apr. 12, 2007

(54) Decorating material made of cycloolefin oligomers

(76) Inventor: Bernd Hoecker, Eltville-Rauenthal (DE)

Correspondence Address: FERRELLS, PLLC, P. O. BOX 312, CLIFTON, VA, 20124-1706, US

(21) Appl. No.: 10/579,869

(22) PCT Filed: Nov. 16, 2004
(86) PCT No.: PCT/EP04/12962

§ 371 Date: May 18, 2006

(30) Foreign Application Priority Data
Nov. 20, 2003 (DE) 103 54 334.1

(51) Int. Cl. C08F 36/00

(52) U.S. Cl. 526/282

(57) ABSTRACT

The invention relates to a material whose technical properties, in particular its optical properties, give it excellent suitability as a decoration material. The material involves oligomeric cycloolefins, in particular cycloolefin homo-oligomers, and also cycloolefin co-oligomers, a characteristic feature of these being a high refractive index and a high Abbé number.

The invention relates to a material whose technical properties, in particular its optical properties give it excellent suitability as a decoration material. The material involves oligomeric cycloolefins, in particular cycloolefin homo-oligomers, and also cycloolefin co-oligomers, a characteristic feature of these being a high refractive index and a high Abbé number.

Decoration materials are usually found among materials which people perceive as attractive. This attractiveness is often due to the shaping, or else due to optical properties, such as color, haze, clarity, reflectance, luster value, etc. By way of example, people perceive crushed glass as attractive, in particular if it has been colored, and crushed glass, if appropriate colored, is therefore nowadays marketed with great success as decoration material.

Many plastics are—like glass—to a large extent amorphous and behave like a solidified melt. If other properties, such as high transparency, high refractive index, and high Abbé number are then also present, these plastics have ideal suitability for use as a decoration material.

Decorative materials composed of, by way of example, acrylic sheet or polycarbonate, for example in the form of relatively large diamonds or relatively large jewels, have been previously disclosed. Previous features of these are high transparency or very little color, and also high density, but on the other hand they also have the disadvantage that their melts have very high strengths, because they are based on structural materials for injection molding and foils. They have to be processed through injection molding machines in order to be converted to a desired shape. This is firstly complicated and secondly expensive, because output per unit of time is very low. Another disadvantage is that the oligomers of these materials are subject to threshold values for toxicity.

There continues to be a need for a low-cost, easy-to-produce, non-toxic, transparent decoration material, for example in the shape of droplets.

The present invention now provides this decoration material. Accordingly, the invention provides a decoration material which is composed of a cycloolefin homo- or co-oligomer whose refractive index n_{D} is preferably from 1.50 to 1.60, particularly preferably from 1.52 to 1.55, and very particularly preferably 1.5435 (in each case measured at 25° C.) and whose Abbé number is preferably from 50 to 60, particularly preferably from 52 to 58, and very particularly preferably 56.

A cycloolefin co-oligomer is an oligomer which is composed of at least one cyclic olefin monomer and of at least one acyclic olefin monomer. A cycloolefin homo-oligomer is an oligomer which is composed of identical or different cyclic olefin monomers.

Suitable Monomeric Cycloolefins are Those of the Formulae I, II, III, IV, V, or VI:

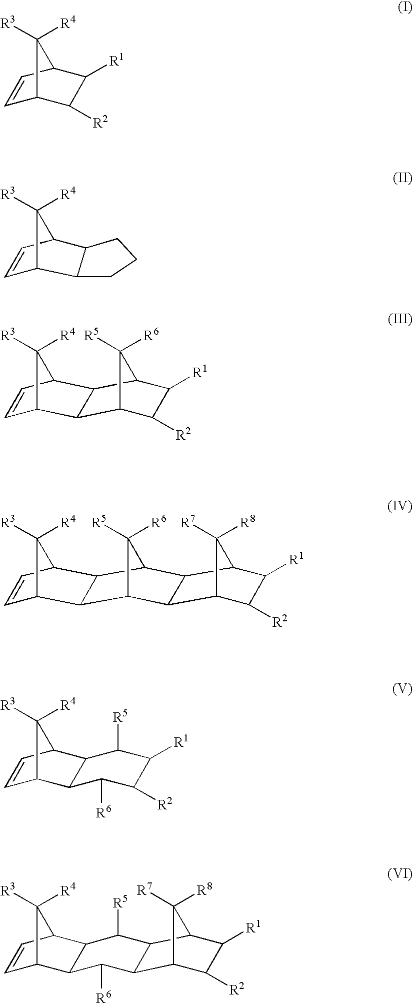

R¹, R², R³, R⁴, R⁵, R⁶, R⁷, and R⁸ in these formulae are identical or different, and, independently of one another, are a hydrogen atom or a C₁-C₃₀-hydrocarbon radical; or two or more of the radicals R¹ to R⁸ have cyclic bonding to one another, and identical radicals in the different formulae here can be identical or different. Examples of preferred C₁-C₃₀-hydrocarbon radicals are linear or branched C₁-C₃₀-alkyl radicals, C₆-C₁₈-aryl radicals, C₇-C₂₀-alkylenearyl radicals, or cyclic C₃-C₂₀-alkyl radicals, or acyclic C₂-C₂₀-alkenyl radicals.

Other Cycloolefins that can be Used are Monocyclic Olefins of the Formula VII: 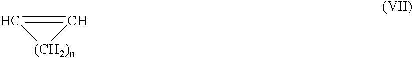
n here is a number from 2 to 10.

Suitable Acyclic Olefins are Those of the Formula VIII:

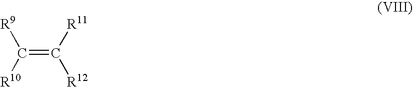

R⁹, R¹⁰, R¹¹ and R¹² here are identical or different and, independently of one another, are a hydrogen atom or a C₁-C₁₀-hydrocarbon radical, e.g. a C₁-C₈-alkyl radical or C₆-C₁₄-aryl radical.

Cycloolefin co-oligomers particularly suitable for the purposes of the present invention are those which contain at least one cycloolefin of the formulae I to VI and at least one acyclic olefin of the formula VIII, as comonomer. Preference is given here to those acyclic olefins VIII which have a total of from 2 to 20 carbon atoms, particular preference being given to unbranched acyclic olefins having from 2 to 10 carbon atoms, e.g. ethylene, propylene, and/or butylene. The proportion of units of acyclic olefins of the formula VIII in the oligomer is up to 99% by weight, preferably from 5 to 80% by weight, particularly preferably from 10 to 60% by weight, based on the total weight of the respective cycloolefin co-oligomer.

Among the cycloolefin homo-oligomers and cycloolefin co-oligomers described above, preference is particularly given to those which contain units of polycyclic olefins having an underlying norbornene structure, particularly preferably containing norbornene or tetracyclododecene. Particular preference is also given to cycloolefin co-oligomers which contain units of acyclic olefins, in particular ethylene. In turn, particular preference is given to norbornene-ethylene co-oligomers and tetracyclododecene-ethylene co-oligomers which contain from 5 to 80% by weight, preferably from 10 to 60% by weight, of ethylene units (based on the weight of the co-oligomer). Among these, very particular preference is in turn given to norbornene-ethylene co-oligomers.

According to the invention, an oligomer is a material which is composed of more than two monomer units but which still does not qualify as a polymer, and this means that the intertwining length (see, for example, Ferry: “Viscoelastic properties of Polymers”, Wiley 1980, pp. 247 et seq.) provides an upper limit on the number of monomers linked within the chain.

In the region below what may be called the critical molecular weight M_{c}, which corresponds to twice the length of the entanglement molecular weight Mₑ, the oligomer exhibits Newtonian flow behavior, and this means that the logarithm of the molecular weight, log M_{w}, is directly proportional to the logarithm of the zero-shear viscosity, log η₀, with gradient m=1. Above the logarithm of the critical molecular weight, log M_{c}, the value of the proportionality constant m is 3.4.

In the case of the monomers used according to the invention, in particular in the case of the norbornene and ethylene monomers, the intertwining length is M_{c}=2*Mₑ=10 000 g/mol, preferably M_{c}=2*Mₑ=8500 g/mol, in particular M_{c}=2′ Mₑ=7200 g/mol. The inventive cycloolefin co-oligomers can also be described via a molar mass of 5000 g/mol, preferably 4250 g/mol, particularly preferably 3600 g/mol (determined by way of gel permeation chromatography GPC at 35° C. in CHCl₃). M_{c} here is the critical molecular weight and Mₑ is the entanglement molecular weight.

It is advantageous for the production of spherical decoration material if the intrinsic viscosity [η] of the cycloolefin co-oligomer is in the range≦25, preferably ≦20, in particular ≦18 (determined to ISO 16289 or, respectively, DIN 53728 at 135° C. in decalin). If the intertwining length is above M_{c}=2 Mₑ>10 000 g/mol, or the molecular weight is above 5000 g/mol, it becomes impossible to form droplets from the molten material, the result being that shaping of the droplets leads to filamenting and further deposition of polymer melt on the filaments leads to what may be called “beading”. On the other hand, if the intertwining length is smaller than M_{c}=2 Mₑ=6000 g/mol, or the molar mass is smaller than 3000 g/mol, the viscosity of the polymer melt becomes so low that rather elongate structures are formed instead of proper droplets.

For particular decorative effects, it has proven advantageous for the density of the polymer beads of the cycloolefin homo-oligomer or cycloolefin co-oligomer to be very slightly below 1.0 g/cm³, advantageously in the range from 0.99 to 1.00 g/cm³, preferably from 0.95 to 1.00 g/cm³ in particular from 0.90 to 0.99 g/cm³. This permits provision of beads which float and have high gloss and high refractive power. Although the density of other plastics, such as polyethylene and polypropylene, is likewise <1.00 g/cm³, they do not have the appropriate gloss and, respectively, the high refractive index. The density of other materials such as polycarbonate or polymethyl methacrylate is so high that decorative beads with density<1.00 g/cm³ cannot be produced from that material. However, when the decorative beads are produced from cycloolefin homo-oligomers or from cycloolefin co-oligomers it is possible to obtain various densities around 1.00 g/cm³, as a function of process conditions.

The cycloolefin oligomers are advantageously prepared via heterogeneous or homogeneous catalysis using organometallic compounds, as described in a wide variety of documents. Suitable catalyst systems based on mixed catalysts composed of titanium compounds and, respectively, vanadium compounds in combination with organylaluminum compounds are described in DD 109 224, DD 237 070, and EP-A-0 156 464. EP-A-0 283 164, EP-A-0 407 870, EP-A-0 485 893, and EP-A-0 503 422 describe the preparation of cycloolefin copolymers (COCs) using catalysts based on soluble metallocene complexes, which are particularly preferred for preparation of the inventive decoration materials. In order to obtain the appropriate molecular weights during the polymerization reaction using organylaluminum compounds, the increase in chain length is monitored by means of viscosity measurement, and on achievement of the critical molecular weight M_{c} the polymerization reaction is regulated or terminated via addition of hydrogen.

The distinguishing feature of the resultant cycloolefin oligomers is very low haze (measured to ISO 14782) of from 1 to 10%, preferably from 2 to 8%, particularly preferably from 3 to 6%. Their clarity/light transmittance (measured to DIN EN ISO 13468-1) is from 90 to 99%, preferably from 92 to 98%, particularly preferably 94 to 97%, and their luster value (measured to DIN EN ISO 2813) is from 85 to 140%, preferably from 90 to 135%, particularly preferably from 95 to 130%. Their refractive index n_{D} (measured to DIN EN ISO 489) is from 1.50 to 1.60, in particular from 1.52 to 1.55, and particularly preferably 1.5435, and their Abbé number (measured to DIN EN ISO 489) is from 50 to 60, in particular from 52 to 58, and particularly preferably 56.

The inventive decoration material composed of the cycloolefin oligomers can assume any desired shape, e.g. spherical, cylindrical, or lamellar; particular preference is given to spherical shape, e.g. in the form of droplets or of flattened spheres. In order to produce these shapes, the cycloolefin oligomers are melted by way of example in an extruder and then by way of example applied in droplet form onto, or spread onto, a conveyor belt. For production of strands or sheets, the cycloolefin oligomer can by way of example be extruded through a perforated dye or slot die and drawn off.

If the density of a cycloolefin oligomer used is very slightly above 1.0 g/cm³—i.e. very slightly above the density of water—i.e. from 1.0 to 1.02 g/cm³, it is possible via variation of the cooling conditions to “freeze” vacuoles within the droplets, thus very slightly lowering the overall density of the resultant droplets (spheres or flattened spheres). The density of the resultant products varies around 1.0 or is below 1.0 g/cm³, and consequently when the resultant decoration material is added to water, as a function of the density of the droplets, some of the material floats, some of the material becomes suspended in the water, and some of it sinks.

The inventive decoration material can by way of example be used as filling of glass vases, in combination with natural and synthetic decoration materials, such as colored sand, carnations, aluminum shavings, moss, dried and/or fresh flowers or flower arrangements, grasses, etc.

The claimed decoration material is also used as an eye-catching material for spreading in window displays or as a display material for table decorations. Another use of the decoration material is filling of containers on which candles are placed, preferably in the form of “night-lights”. An advantage of the claimed decoration material composed of cycloolefin oligomers here is that in accordance with the DIN 4102-1 fire classification requirements for construction materials class B1 and B2, the melt complies not only with construction materials class B2 (edge flame application in combustion frame to DIN 50050-1) but also with the requirements for construction materials class B1, and is therefore of low flammability.

One property of decorative beads composed of cycloolefin oligomers or of cycloolefin co-oligomers when used in the form of spheres or of flattened spheres or, respectively, ellipsoid is that their surfaces bundle ambient light or the light from directional or non-directional light sources, the result therefore being light amplification. This effect is similar to that of a concave mirror when the location of the light source is between focal point and the surface of the concave mirror, the result therefore being a magnified virtual image.

Test Methods

The Following Test Methods were Used for Determination of Product Properties:

Determination of Degree of Intertwining

The dependency of zero-shear viscosity of linear oligomers/polymers of low molecular weight divides into two regions:
η₀∝M_{w} for M_{w<M}_{c} where M_{w}=weight-average molecular weight
η₀∝M_{w}^{3.4} for M_{w}>M_{c} where M_{c}=critical molecular weight

Polymers whose molecular weight is higher than the critical molecular weight M_{c} can intertwine, and as a consequence of this the molecular-weight dependency of viscosity is very much higher.

If log M_{w} is then plotted in a double-logarithmic graph against log η₀, i.e. the logarithm of the weight-average molecular weight against the logarithm of zero-shear viscosity, there is then direct proportionality between log M_{w} and log η₀ in the region of the relatively low values. This is the Newtonian region of a polymer melt and is attributed to the oligomers. Intertwining of the oligomers does not begin to happen until the critical molecular weight has been exceeded, and they are then therefore termed polymers. The gradient of the plot of log M_{w} against log η₀ is then 3.4.

The critical molecular weight is therefore determined via a plot of different weight-average molecular weights against the corresponding zero-shear viscosity, the result being a plot whose gradient m is 1 in the lower molecular weight region and whose gradient m is 3.4 in the higher molecular weight region. The critical molecular weight M_{c} occurs at the point where the two straight lines intersect.

Determination of Intrinsic Viscosity

The derivative of viscosity with respect to concentration is termed the generalized Staudinger index {η}. This means that δ in η/δ c₂={η}. The Staudinger index is obtained by obtaining the limiting value for c→0 (infinite-dilution limit) and γ/δs→0 (infinitely-small-shear-rate limit), and, represented in visual terms, is the volume occupied by the convoluted structures formed from one gram of polymer in infinitely dilute solution:

$${lim}_{\begin{matrix}{c}_{2} \to 0 \\ y \dot{->} 0\end{matrix}} \{ η \} = [ η ] = {{lim}_{{c}_{2} \to 0}}_{y \dot{->} 0} \frac{{η}_{Spec}}{c}$$

where [η] is in ml/g, and c₂=conc. of oligomer in the solution.

Since the Staudinger index (intrinsic viscosity) concerns a limiting value, the determination method uses the reduced viscosity. This is determined at various concentrations and can be extrapolated to c₂=0 with the aid of empirical equations.

The Staudinger index is measured in capillary viscometers, by dissolving very small amounts of the oligomer or polymer in a series of concentrations in CHCl₃ and measuring the time taken by this solution to pass through the capillary viscometer. These times are reduced by the flow time for the pure solvent. A table of flow times gives the associated viscosity. This is divided by the concentration of the oligomer in the solution and plotted against concentration. Extrapolation of this series of concentrations to 0 gives the Staudinger index.

Examples are used below for illustration of the invention:

### EXAMPLES

Preparation of a Cycloolefin Co-Oligomer

Preparation of tetracyclododecene-ethylene co-oligomers and of norbornene-ethylene co-oligomers

(The termination reaction is brought about via treatment of the reactive solution with acetone, and the ethylene/norbornene incorporation rates are regulated via hydrogen content).

600 cm³ of a solution of tetracyclododecene (TCD) or dicyclopentadiene (DCPD) in toluene are used as initial charge in a 1.5 dm³ autoclave, which has been adequately pre-purged with ethylene. 5 cm³ of a methylaluminoxane solution in toluene (Crompton; 10% strength, based on the weight of the methylaluminoxane solution with molar mass of 1000 g/mol determined by a cryoscopic method) are metered in countercurrent into the reactor which has been appropriately prepared, i.e. previously evacuated and freed from atmospheric moisture, and the mixture is stirred at 70° C. for 10 min. This solution is then saturated with ethylene with a mixture of ethylene and 5% of hydrogen, via repeated pressure equalization. A solution of 0.004 mmol of the metallocene complex [Me₂C(Ind)₂]ZrCl₂ in 10 cm³ of methylaluminoxane solution in toluene is then added after an activation time of 15 min. Activation takes place via chemical reaction of the two components with one another. Oligomerization is carried out by means of stirring (750 rpm) until complete consumption of 7 liters of ethylene has occurred, the ethylene pressure being maintained via supplementary metering, and the temperature being kept at 70° C.

After the end of the reaction time, the solution is discharged into a vessel and immediately treated with 5 dm³ of acetone and stirred for 10 min, and the precipitated cycloolefin co-oligomer is then isolated by filtration. The filter cake is washed with three portions of a 10% strength HCl solution alternating with acetone, and the residue is slurried with acetone and again filtered. The resultant purified oligomer is dried for 15 hours at 45° C. at subatmospheric pressure (0.2 bar).

Properties of oligomer: The method described above gives an oligomer which is glass-clear and which is entirely amorphous because of its molecular structure or, respectively, the arrangement of ethylene and norbornene. This means that the cycloolefin oligomer has no crystal lattice of any kind and therefore also has absolutely no crystalline content. It solidifies to give a glassy material and can be liquefied again via heating above what is known as the glass transition temperature. If the temperature falls below the glass transition temperature, the cycloolefin oligomer solidifies again to give a glassy material with higher transparency and high gloss.

Production of a Decoration Material

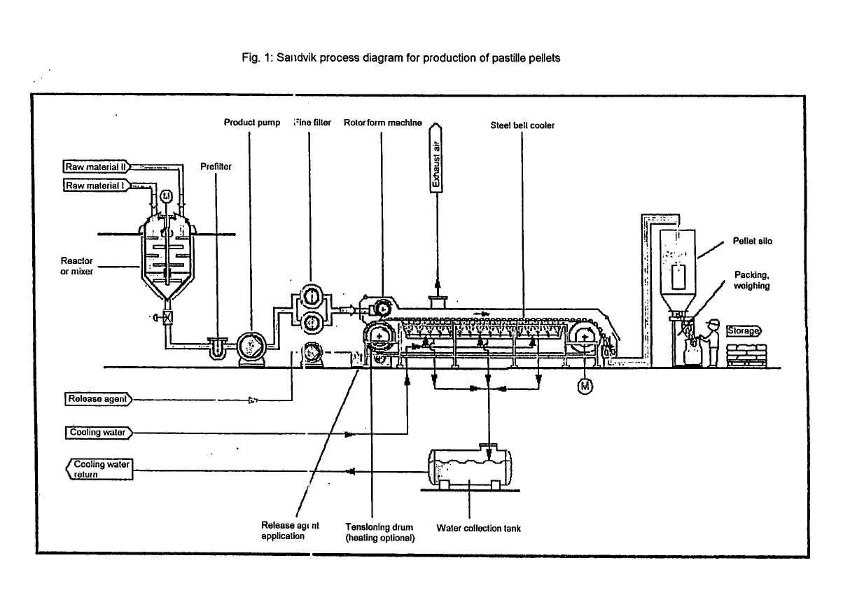

The TCD oligomer from Example 1 was processed by the Sandvik/Fellbach Rotoform process (see FIG. 1) to give pastilles.

The pastille production process consists of the Sandvik Rotoform dropletizer (1), which applies the liquid oligomer melt to a continuously circulating steel belt (2). Cooling water (3) is sprayed onto the underside of the steel belt and the resultant optimized heat exchange rapidly solidifies the droplets. This process molds molten products directly into pellets and pastilles, thus making comminution or grinding entirely superfluous. This reduces costs and prevents environmental pollution via dust or noise.

The continuously operating Sandvik steel-belt cooler provides indirect heat exchange, so that neither the oligomer melt nor the cooling water becomes contaminated and the water can easily be discharged or returned into the system. The pastilles produced in these plants are so abrasion-resistant that the workplace environment remains dust-free easily even at high throughputs. Absolutely no measures for cleaning exhaust air are therefore needed.

This system therefore provides a combination of simple process technology, high efficacy, excellent product quality, and minimal environmental pollution.

To produce these decorative beads with different density, it is necessary to control the cooling conditions specifically. If the intention is to obtain decorative beads whose density is above 1.00 g/cm³, the cooling process has to be controlled so that the melt is cooled below what is known as the glass transition temperature. The glass transition temperature of the cycloolefin oligomers is from 60 to 70° C., preferably from 62 to 68° C., and particularly preferably 65° C.

The quenching or solidification of the melt can be controlled by way of the cooling rate or cooling speed, which is a function of the melt temperature difference and of the temperature of the coolant and the residence time. Since the melt cools from the outside, i.e. the interface between the oligomer droplet and the atmosphere or the steel belt, toward the inside, vacuoles of varying size form as a function of the cooling rate, via the shrinkage of the cycloolefin oligomer melt. The overall density of the decorative beads can be controlled by way of the size of the vacuoles, and it is therefore possible for the density of some of the decorative beads to be 1.02 g/cm³, meaning that they have no vacuoles and therefore, for example, sink in water, and also for the density of some of the beads to be precisely 1.00 g/cm³ so that they, for example, remain suspended in water, and also for the density of some of the beads to be lower, below 1.00 g/cm³, so that they, for example, float on the surface of the water.

For supplying material to the Rotoform machine for production of the decorative beads, either a melt stream is discharged from the synthesis reactor or previously prepared cycloolefin oligomer is introduced in a static mixer or via an extruder and melted and passed to the Rotoform machine by way of heated melt lines. It is important here that the melt has firstly been homogeneously melted and secondly that the melt is free from gases. In the case of the static mixer, this is achieved via a vacuum over the melt, and in the case of the extruder, this device provides degassing via the compaction of the melt against the direction of conveying, and in the case of supply of material via the synthesis plant, the process conditions mean that absolutely no gases are present in the melt.

Entrained gases in the melt lead to formation of very small bubbles during the molding of the decorative beads in the Rotoform machine as a consequence of the difference in density between air and oligomer melt, and specifically form preferentially on the surface of the melt and then impair the luster of the beads because their very small size produces a high level of light-scattering. Decorative beads of this type are perceived as cloudy when compared with those whose melt is free from bubbles. Surprisingly, any vacuoles which may form in the interior do not interfere with the luster of a decorative bead but provide additional interesting refractive reflection effects.

Another reason for avoiding inclusion of any gases, in particular oxygen, in the melt is possible oxidative attack on the monomers in the cycloolefin oligomers, which can lead to an undesired yellow to brown coloration via oxidative degradation.

The temperature of the oligomer melt is from 150 to 300° C., preferably from 180 to 280° C., and particularly preferably from 200 to 260° C. The intrinsic viscosity of the melt at these temperatures is ≦15 Pas, preferably ≦12 Pas, and particularly preferably ≦10 Pas. The production conditions are selected in such a way that the melt has sufficiently high viscosity to form large droplets but at the same time sufficiently low viscosity to avoid filamenting from the melt when the melt is spread onto the Sandvik belt. The temperature of the coolant has to be at least lower than the glass transition temperature of the cycloolefin oligomer, in order that these undergo appropriate shaping and hardening. Furthermore, the residence time on the Sandvik belt has to be long enough for the oligomer melt to cool below the glass transition temperature, because otherwise there is a risk that the decorative beads will cake during bagging-off or packing. One property of the cycloolefin homo-oligomer or cycloolefin co-oligomers which is significant for the application is that they are not tacky after solidification and therefore do not stick to one another via Van der Waals forces or other adhesive forces. The cooling temperature required for the cooling water varies within the limits of from 5 to 70° C., preferably from 10° C. to 25° C., and particularly preferably from 15 to 20° C. The shape and size of the decorative beads can be varied by way of the amount spread of the melt, the belt speed, the melt temperature, and also the cooling rate and, respectively, temperature difference between the melt and the coolant, and also the residence time. For example, decorative beads of almost perfect spherical shape can be produced under suitable conditions, i.e. relatively low melt temperature, slow belt speed, small to moderate amount of melt, and a high level of countercurrent cooling. If melt temperatures are very high, belt speed is high, amount of melt is high, and there is very little countercurrent cooling, the result is rather elongate ellipsoidal decorative beads.

The ratio of the axes a:b:c of the decorative beads can vary within the limits from 1:1:1 (ideal spherical shape) to 10:1:1 or 1:10:1 or 1:1:10 (ellipsoidal shape). The process can cause deviation from the spherical shape because the melt is deposited on the cooling belt and initially while it remains molten its own weight can cause some flattening due to gravity on the side directly in contact with the cooling belt. Flattening is also promoted when the cooling temperature of the belt of the Rotoform machine is particularly low. There is then a particularly high level of heat transfer to this belt, while there is relatively little heat transfer to the ambient air, because neither the oligomer melt nor the air has good thermal conductivity. The melt therefore cools more slowly at that phase boundary than in the direction of the belt, and this promotes continued flow of the melt. This can be prevented or influenced by additionally cooling the air which surrounds the decorative beads located on the cooling belt.

Properties of Resultant Decoration Materials

A cycloolefin co-oligomer was used composed of ethylene and norbornene with molar mass M_{w}=3700 g/mol (determined via GPC at 35° C. in CHCl₃). The conditions for production of the decorative beads were selected as follows:

### Example 1

The amount of oligomer melt throughput passed from the synthesis reactor to the Sandvik belt was regulated to 1.5 metric tons per hour per belt. The melt temperature was 190° C. and the temperature of the pipe was 225° C. Cooling zone 1 was regulated to 10° C. with water throughput of 7 m³/h, and cooling zone 2 was likewise regulated to 10° C. with water throughput of 12 m³/h, and the air cooling was regulated to 20° C. and 5000 m³/h. Droplet frequency was adjusted to 65% of belt speed. Residence time on the Sandvik belt was about 30 sec.

### Example 2

The amount of oligomer melt throughput passed from the synthesis reactor to the Sandvik belt was regulated to 1.5 metric tons per hour per belt. The melt temperature was 180° C. and the temperature of the pipe was 215° C. Cooling zone 1 was regulated to 7° C. with water throughput of 10 m³/h, and cooling zone 2 was likewise regulated to 7° C. with water throughput of 18 m³/h, and the air cooling was regulated to 10° C. and 5000 m³/h. Droplet frequency was adjusted to 75% of belt speed. Residence time on the Sandvik belt was about 60 sec.

### Example 3

The amount of oligomer melt throughput passed from the synthesis reactor to the Sandvik belt was regulated to 1.5 metric tons per hour per belt. The melt temperature was 185° C. and the temperature of the pipe was 220° C. Cooling zone 1 was regulated to 8.5° C. with water throughput of 8.5 m³/h, and cooling zone 2 was likewise regulated to 10° C. with water throughput of 15 m³/h, and the air cooling was regulated to 15° C. and 5000 m³/h. Droplet frequency was adjusted to 70% of belt speed. Residence time on the Sandvik belt was about 45 sec.

Properties of Decorative Beads:

| Ex- | | | | Clar- | Luster | Staudinger | Refractive |
|---|---|---|---|---|---|---|---|
| am- | Density | Abbé | Haze | ity | value | index | index n_{D} |
| ple | [g/cm₃] | number | [%] | [%] | [%] | [ml/g] | (25° C.) |
| 1 | 1.02 | 56 | 2 | 98 | 135 | 18 | 1.5435 |
| 2 | 0.95 | 54 | 2 | 98 | 135 | 18 | 1.5435 |
| 3 | 1.00 | 55 | 2 | 98 | 135 | 18 | 1.5435 |

1. A decoration material which is comprised of a cycloolefin co-oligomer whose refractive index n_{D} (25° C.) is from 1.50 to 1.60 and whose Abbé number is from 50 to 60.

2. The decoration material as claimed in claim 1, wherein the oligomer is composed of at least one cyclic olefin monomer and of at least one acyclic olefin monomer.

3. The decoration material as claimed in claim 2, wherein the cycloolefin co-oligomer is a norbornene-ethylene or tetracyclododecene-ethylene co-oligomer.

4. The decoration material as claimed in claim 3, wherein the intertwining length M_{c} of the oligomer=2*Mₑ=10 000 g/mol.

5. The decoration material as claimed in claim 4, wherein the molar mass of the cycloolefin co-oligomer is <5000 g/mol.

6. The decoration material as claimed in claim 5, wherein the average chain length of the cycloolefin co-oligomer is smaller than 2*Mₑ.

7. The decoration material as claimed in claim 6, wherein the intrinsic viscosity [η] of the cycloolefin co-oligomer is in the range from ≦25 to ≦15.

8. The decoration material as claimed in claim 7, wherein the density of the cycloolefin co-oligomer is from 0.95 to 1.05 g/cm³.

9. The decoration material as claimed in claim 8, wherein the haze of the cycloolefin co-oligomer is from 1 to 10%.

10. The decoration material as claimed in claim 1, wherein the clarity of the cycloolefin co-oligomer is from 50 to 99%.

11. The decoration material as claimed in claim 1, wherein the luster value of the cycloolefin co-oligomer is from 85 to 140%.

12. The decoration material as claimed in claim 1, which is spherical, cylindrical, or lamellar.

13. A process for production of a decoration material as claimed in claim 1, which comprises melting a cycloolefin co-oligomer, and converting it into the desired shape in the molten state and then cooling it.

14. A process for production of a decoration material as claimed in claim 1, which comprises melting a cycloolefin co-oligomer, converting it to the desired shape in the molten state and then using a Sandvik belt to cool it in such a way as to produce marked shrinkage in the decorative beads, so that the density of the decorative beads is <1.00 g/cm³.

15. A mixture composed of two or more decoration materials as claimed in claim 1, where the density of at least one portion of the decoration material is greater than 1.0 g/cm³ and the density of another portion is smaller than and/or equal to 1.09 g/cm³.

16. The use of a decoration material as claimed in claim 1 as filler material in vases, as display material in display windows, or as table-decoration material.
